(19) United States
(12) Patent Application Publication
(10) Pub. No.: US 2020/0051013 A1
(43) Pub. Date: Feb. 13, 2020

(54) SYSTEM AND METHOD FOR INTEGRATED ROUTE MANAGEMENT

(71) Applicant: Gordon David McIntosh, Austin, TX (US)

(72) Inventor: Gordon David McIntosh, Austin, TX (US)

(21) Appl. No.: 16/280,014

(22) Filed: Feb. 19, 2019

Related U.S. Application Data
(60) Provisional application No. 62/710,553, filed on Feb. 22, 2018.

(51) Int. Cl. G06Q 10/08; G06Q 50/26; G01C 21/34

(52) U.S. Cl. CPC G06Q 10/0833; G06Q 10/0832; G01C 21/3461; G06Q 50/26

(57) ABSTRACT

Methods and systems to prevent autonomous vehicle misuse using integrated route management are disclosed. Embodiments include a server architecture that implements route management of autonomous vehicles within Federal, State, and Local Jurisdictions as well as implement intelligent tracking to eliminate fraud and illegal shipments. An AV in the context of his patent is a vehicle meeting the definition of Society of Automotive Engineers (SAE) Level 2 to 5 as defined in SAE specification J3016, or an autonomous aerial vehicle.

### CROSS-REFERENCE TO RELATED APPLICATIONS

The present application claims priority to U.S. Provisional Application No. 62/710,553, filed Feb. 22, 2018, the disclosures of which are incorporated by reference herein in their entirety.

### TECHNICAL FIELD

The present invention relates generally to an improved data processing system and in particular to a method and apparatus for implementing secure route management for Autonomous Vehicle (AV). Still more particularly, the present invention provides for integrated route management of autonomous vehicles within Federal, State, and Local Jurisdictions.

### BACKGROUND OF THE INVENTION

The field of autonomous vehicle control is currently emerging as a promising technology that can reduce costs, reduce accidents and loss of life, reduce insurance premiums, increase productivity for workers in transit and potentially eliminate drunk driving and the associated losses; however, recent misuse of vehicles by terrorists demands that the technology be proactive to develop a comprehensive threat model, as well as mitigation and prevention methodologies rather than reacting to the consequences.

Autonomous vehicles are categorized by the Society of Automotive Engineers (SAE) in specification J3016, Autonomy Levels as follows:
Level 0: Automated system issues warnings and may momentarily intervene but has no sustained vehicle control.
Level 1: Driver and automated system shares control over the vehicle. An example would be Adaptive Cruise Control (ACC) where the driver controls steering and the automated system controls speed. Using Parking Assistance, steering is automated while speed is manual. The driver must be ready to retake full control at any time.
Level 2: The automated system takes full control of the vehicle accelerating, braking, and steering. The driver must monitor the driving and be prepared to immediately intervene at any time if the automated system fails to respond properly.
Level 3: The driver can safely turn their attention away from the driving tasks—e.g. the driver can text or watch a movie. The vehicle will handle situations that call for an immediate response, like emergency braking. The driver must still be prepared to intervene within some limited time when called upon by the vehicle to do so (specified by the manufacturer).
Level 4: As level 3, but no driver attention is ever required for safety, i.e. the driver may safely go to sleep or leave the driver's seat. Self driving is supported only in limited areas or under special circumstances, like traffic jams. Outside of these areas or circumstances, the vehicle must be able to safely abort the trip, i.e. park the car, if the driver does not retake control.
Level 5: No human intervention is required. e.g., robotic taxi.

Because of this recent technology's development, there are currently no commercially available autonomous vehicles available for sale in the USA, however, it is estimated that in ten (10) to fifteen (15) years, the vast majority of trucking will rely on fully autonomous vehicles. The advantages of full autonomous operations are obvious; however, he very nature of an autonomous vehicle provides a large measure of anonymity and therefore the possibility of subsequent misuse.

The American Trucking Associations (ATA) in Arlington VA., published the following statistics as of July 2017 that underscore the impact AVs will have on the economy as drivers are replaced and alternate forms of energy, such as electric, replace diesel fuel. Although these statistics cite the trucking industry in the U.S., countries worldwide have very similar industry statistics:
1. There are 3.63 million class 8 trucks on the road in the United States and 11.7 million commercial trailers were registered in 2015.
2. There are 586,014 for-hire carriers and 747,781 private carriers in the United States; 97.3 percent of them have fewer than 20 trucks and 90.8 are operating six trucks or less.
3. The trucking industry consumed 54.3 billion gallons of diesel fuel and gasoline in 2016. Based on consumption and price, ATA reported that motor carriers spent $142.9 billion in 2015.
4. Professional truck drivers drove over 273.9 billion miles in 2015, more than double 25 years ago. Those miles accounted for 14.2% of all motor vehicle miles and 29.8% of all truck miles.
5. The trucking industry paid $41.3 billion in federal and state highway taxes in 2014, and represented 12.1 percent of vehicles on the road. The trucking industry paid $18.7 billion in federal highway-user taxes and $22.6 billion in state highway-user taxes in 2015.
6. The federal fuel tax for diesel in 2015 is 24.4 cents per gallon; the average state tax for diesel fuel was 27.4 cents per gallon.
7. There are 3.5 million truck drivers in the United States. Total industry employment is 7.4 million or one out of every 16 people working in the United States.
8. In 2016, the trucking industry hauled 10.55 billion tons of freight, or 70.9 percent of total U.S. freight tonnage. Rail was the next busiest mode, moving 13.8 percent of the nation's freight tonnage.
9. In 2016, the trucking industry was an astounding $738.9 billion industry, representing 81.5 percent of the nation's freight bill.
10. More than 80 percent of U.S. communities depend solely on trucking for delivery of their goods and commodities.

The financial reward for moving to fully autonomous electric vehicles is so compelling that it is unlikely to be delayed once the technology and regulations are in place. Consider the following:
1) Currently, a driver occupied diesel Class 8 truck overhead cost is $0.12/ton-mile
2) Electric vehicles will save $0.02/ton-mile, factoring increased vehicle costs, lower fuel costs, and lower maintenance
3) Autonomous vehicles will save $0.06/ton-mile
4) Autonomous electric vehicles will save $0.08/ton-mile or 66.7% of today's overhead cost.

Currently, there is a flurry of activity in federal and state legislatures as the Federal Governments and State Governments across the world become aware that gasoline and diesel taxes will vanish as electric vehicles start to dominate. Unfortunately, these activities have resulted in many independent efforts that focus largely on the lost revenue but lack cohesion, i.e., no unified national solution has been considered. Because the shift to electric vehicles represents very large potential losses in revenue, it must be addressed; in the US alone:
1) Currently, diesel fuel federal taxes are $0.244 per gallon, Stated taxes range from a low of $0.1275 per gallon to $0.747 with a nationwide average of $0.3101 per gallon. Additionally, eight (8) states levy local taxes as well. Given a usage of 38.8 billion gallons in 2016, significant tax loss will be incurred by all jurisdictions as the fleets convert to electric. ($0.244+$0.3101) * 38.8 billion gallons)=$25.5 B.
2) The trucking industry paid $18.7 billion in federal highway-user taxes and $22.6 billion in state highway-user taxes in 2015, totaling 41.3 B.
3) As AVs convert to electric, the $25.5 B will need to be moved to highway usage fees, taxes on the electricity used for charging vehicles, or other means; however, unless

Unfortunately, there is a lack the cohesion and intent that will minimize damage to the industry, factor in improvements, and provide necessary security measures. None of the proposals have made any improvement in prevention of illegal cargo, in fact, there is no current means (or proposed) to estimate the volume of illegal cargo shipped into and within the U.S. Additionally, many regulations proposed will continue to burden the industry and when the vast majority of truckers are independent operators with less than six (6) vehicles, additional regulations can be especially damaging.

Major paradigm shifts such as the adoption of all electric autonomous vehicles certainly causes disruption; however, they also present an opportunity to institute positive changes. Previous changes to the trucking industry have occurred incrementally over many years; however, technology has progressed in ways that can offer major improvements to every aspect of this business. Currently, there are few means other than physical inspection to prevent the transport of illegal cargo such as hazardous cargo without authorization, transport of human cargo (human smuggling) and/or the transport of terrorist cargo; unfortunately, these all require law enforcement manpower that is not available.

Additionally, the emergence of autonomous drones as service vehicles is progressing rapidly. These autonomous vehicles cause disruption just because of their presence in certain areas such as airports, helipads, or other restricted airspace. Helipads are common at hospitals, law enforcement locations, hotels, and rooftop sites such as Emergency Helicopter Landing Facilities (EHLF).

It is readily apparent that many threats face this rapidly emerging industry, and although already burdened with extensive regulations, many issues remain unsolved; therefore, it would be advantageous to have an improved method and apparatus to prevent autonomous vehicle misuse through integrated route management.

### SUMMARY OF THE INVENTION

The present invention provides a system, method and apparatus to prevent Autonomous Vehicle (AV) misuse. The exemplary aspects of the present invention details an effective and secure methodology to implement route management of autonomous vehicles within Federal, State, and Local Jurisdictions as well as implement intelligent tracking to eliminate fraud and illegal shipments. An AV in the context of his patent is a vehicle meeting the definition of Society of Automotive Engineers (SAE) Level 2 to 5 as defined in SAE specification J3016, or autonomous aerial vehicle.

### BRIEF DESCRIPTION OF THE DRAWINGS

The novel features believed characteristic of the invention are set forth in the appended claims; however, the invention itself, as well as a preferred mode of use, further objectives and advantages thereof, will best be understood by reference to the following detailed description of an illustrative embodiment when read in conjunction with the accompanying drawings, wherein:

FIG. 1 is a block diagram depicting a Route Processing System;

FIG. 2 is a block diagram depicting the State Jurisdiction Processing System portion of the Route Processing System;

FIG. 3 is a block diagram depicting the Federal Jurisdiction Processing System portion of the Route Processing System; and

FIG. 4 is a block diagram depicting an alternate State Jurisdiction Processing System portion of the Route Processing System.

### DETAILED DESCRIPTION OF THE INVENTION

The detailed description set forth below, in connection with the appended drawings, is intended as a description of various possible configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

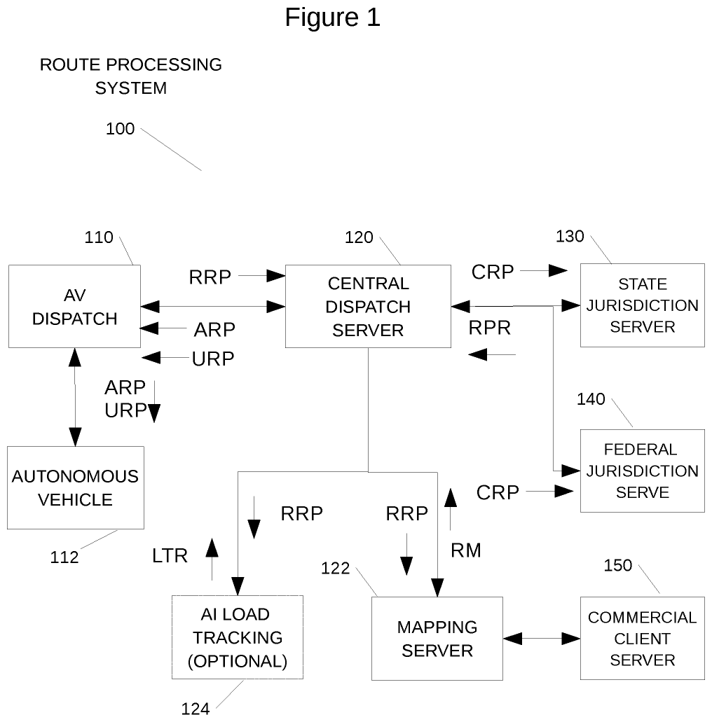

With reference now to the figures, and in particular with reference to FIG. 1, a block diagram depicting a Route Processing System 100 in accordance with a preferred embodiment of the present invention. Those of ordinary skill in the art will appreciate that the system may vary according to the manufacturer, design requirements, requirements mandated by local and federal regulatory bodies, as well as intended usage. Depicted in FIG. 1 is AV Dispatch 110, an Autonomous Vehicle 112, Central Dispatch Server 120, Mapping Server 122, (Optional) Al Load Tracking 124, State Jurisdiction Server 130, Federal Jurisdiction Server 140, and Commercial Client Server 150.

AV Dispatch 110 represents one of the secure, web-based client interfaces operated at the for-hire carriers or private carriers requesting route and route authorization from the Central Dispatch Server 120; additionally, AV Dispatch 110 facilities could be provided at all U.S. border crossings where route and route authorization could be obtained for AVs arriving from outside the U.S. Those of ordinary skill in the art will recognize that web-based client interfaces offer significant advantages such as a standard, consistent user experience, worldwide access, secure client access, easy installation and update, low unit cost, and centralized development and maintenance; however, also have disadvantages that must be fully addressed such as such as reliance on Internet connectivity, necessity for browser support, as well as possible security issues.

AV Dispatch 110 transmits a Route Request Package (RRP), to Central Dispatch Server 120 and waits for an Approved Route Package (ARP). The ARP is a signed package containing authorization and route data; the route data in the ARP is in a standard format such as the GPS Exchange Format. Those of ordinary skill in the art will appreciate that the route data format may vary or change over time as factors such as the design requirements and jurisdictional requirements change.

The information required for the RRP that is sent to AV Dispatch 110 includes, but is not limited to, vehicle identifier, AV make and model, operator's and driver's license (if present), permit numbers, load manifest (machine readable), current location, destination, desired departure time, desired arrival time, GPS type, fuel type, allowable distance per segment, customer id(s) and customer invoice number(s). The manifest can be electronically cross checked by product, quantity and weight between the shipper and receiver, thus providing a mechanism to detect illicit shipments. Those of ordinary skill in the art will appreciate that the information required may vary or change over time as factors such as the design requirements and jurisdictional requirements change.

All information transmit to and from the Central Dispatch Server 120 must be electronically signed using Public Key Infrastructure (PKI) certificates, or equivalent, and transmit securely using a link that provides mutual authentication to guarantee endpoint identification and authorization, message integrity, message confidentiality, non-repudiation of origin and non-repudiation of receipt. User identification and authorization is necessary to guarantee unauthorized interference, message integrity is required to ensure the message is received correctly so it may be interpreted properly, and message confidentiality is required to prevent spoofing or other hacking techniques. Non-repudiation of origin is required to ensure the AV's owner/dispatcher has sufficient records and non-repudiation of receipt is required so the origin (ownership) of the AV can be verified. Those of ordinary skill in the art will appreciate that protocols such as Transport Layer Security Version 1.2 (TLSv1.2) may be used to achieve the necessary link security; however, they will also recognize non-repudiation of origin and non-repudiation of receipt are required whether provided as an extension to TLSv1.2 or as part of the application layer.

When the ARP is received by AV Dispatch 110, the signature is validated and then transmit securely to the control system of the Autonomous Vehicle (AV) 112, after which, the AV 112 is authorized for dispatch to it's destination. The AV control system (not shown) may be

1. An AV Control Computer or

2. An Override Control System and an AV Control Computer.

In case 1 above, the AV Control Computer validates the ARP and navigates the specified route with no oversight. In case 2 above, the Override Control Systems validates the ARP, and if valid, transmits the ARP to the AV Control Computer which navigates the specified route; additionally, the Override Control System continuously compares the route of the AV against the ARP, and if the route taken deviates significantly from the ARP route, the Override Control System can alert law enforcement and dispatch, as well as shutdown the AV operation.

During transit, the AV Control System of the AV 112 must remain in contact with their AV Dispatch 110 to ensure Updated Route Packages (URP) be received. Transmission of the URP to the AV can be accomplished by secure radio link, or other secure means as provided. The AV Control System processes the in the same manner as the ARP. Neither the AV Control System of AV 112, nor AV Dispatch 110, have any knowledge of the processes involved in the route processing performed by Central Dispatch Server 120; this ensures no disclosure of sensitive or classified information from the State Jurisdiction Server 130 or the Federal Jurisdiction Server 140.

The Central Dispatch Server 120 receives the signed RRP from AV Dispatch 110, validates the signature and information within the RRP, then forwards to the Mapping Server 122 to produce and return a Route Map (RM). Upon receipt of the RM, the Central Dispatch Server 120 electronically signs the RM, combines with the RRP into the Combined Route Package (CRP), and forwards to the State Jurisdiction Server 130 where the CRP is examined; upon approval, the State Jurisdiction Server 130 electronically signs and returns a Route Package Response (RPR), the CRP is then forwarded to the Federal Jurisdiction Server 140 for examination. Again, upon approval, it is electronically signed and a RPR is returned to the Central Dispatch Server 120. When the signed RPR is approved and returned by the Federal Jurisdiction Server 140, the Central Dispatch Server 120 signs and transmits an ARP to the AV Dispatch 110. Additionally, the Central Dispatch Server 120 monitors traffic patterns, State Jurisdiction Server 130, Federal Jurisdiction Servers 140, and Commercial Client Server 142 for updates that need be returned to AV Dispatch 110 to be forwarded to the AV 112 as an URP. The Commercial Client Server 142 provides an interface for AV support service providers such as charging and fueling stations, normal and emergency maintenance facilities, vehicle inspection stations, and others as necessary. Route optimization can use the service providers data such as location, price structure, and availability, both for the original route map as well as updated route maps.

Also shown on FIG. 1 is optional Al Load Tracking 124 is shown that allows authentication of load order and load delivery be implemented in a closed loop; Al Load Tracking 124 receives the RRP from the Central Dispatch Server 120, performs the required analysis, and returns a Load Tracking Response (LTR) to Central Dispatch Server 120. Those of ordinary skill in the art will recognize that there is an order cycle driving the need for trucking; goods are not shipped to random destinations but are shipped to customers that ultimately pay for the cost of shipping. By having access to the AV manifest, customer id(s), and customer invoice number(s), the data can be used to validate AV load authenticity; load that cannot be electronically authenticated in Al Load Tracking 124 would be indicated in the LTR and flagged for manual inspection by the Central Dispatch Server 120. Moreover, Al Load Tracking 124 allows the detection of patterns that would not be detectable otherwise; these patterns could be indicators of fraudulent or illegal use. Load Tracking is an independent function from the route map and is not used in generation of the RM or the ARP.

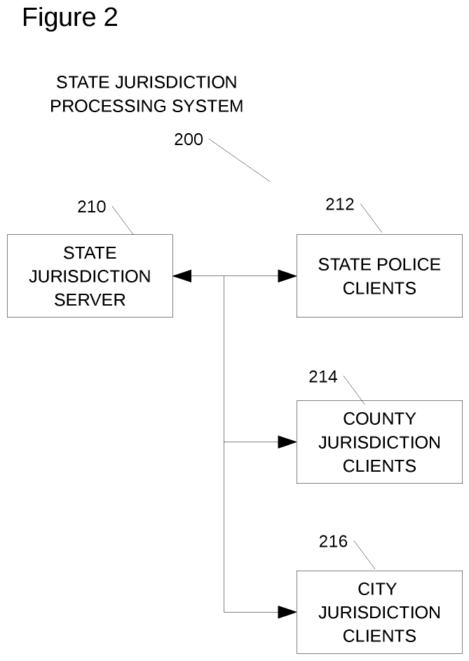

Turning now to FIG. 2, a diagram depicting the State Jurisdiction Processing System 200, in accordance with a preferred embodiment of the present invention; it includes the State Jurisdiction Server 210, and attached clients, the State Police Clients 212, County Jurisdiction Clients 214, and City Jurisdiction Clients 316.

Each of the attached clients is tasked with providing street, area, or route restrictions; these restrictions indicate if the restriction is permanent, or temporary, if temporary time data is provided. Those of ordinary skill in the art will appreciate that the information required may vary or change over time as factors such as the design requirements and jurisdictional requirements change. The primary purpose of each client is the protection of assets under its jurisdiction; however, other than the restrictions listed, no information is returned to the Central Dispatch Server 120, shown in FIG. 1, that indicates why the restriction is in place or what agency returned the restriction. The State Jurisdiction Server 210 is responsible for analysis of multiple requests that may attempt to discover sensitive or classified information through side channel analysis.

Each of the attached clients, the State Police Clients 212, County Jurisdiction Clients 214, and City Jurisdiction Clients 316, are responsible for returning restrictions regarding their designated areas; e.g., the State Police Clients 212 are primarily responsible for returning restrictions concerning the protectees within their jurisdiction; however, they may also return other restrictions regarding their designated areas. The County Jurisdiction Clients 214, and City Jurisdiction Clients 216, each are responsible for returning restrictions regarding their designated areas. All restrictions are maintained in a database, or other data structure, contained within and maintained by the State Jurisdiction Server 210. Those of ordinary skill in the art will appreciate that in the U.S. there are fifty (50) state jurisdictions as well as the District of Columbia, over 3000 counties and county-equivalents, and almost 20,000 incorporated cities; therefore, the restrictions required by these jurisdictions may vary.

As explained above, the State Jurisdiction Server 210 receives a signed CRP from the Central Dispatch Server 120, shown in FIG. 1; after validating the package electronic signature, the State Jurisdiction Server 210 compares the route contained in the Route Map to the restrictions in the database. If a restriction collides with the route, the route is rejected with a list of each collision and any relevant time data. The Central Dispatch Server 120, shown in FIG. 1, searches for an alternate route, meeting the restrictions, until found and re-sends to the State Jurisdiction Server 210. When the route is approved, the State Jurisdiction Server 210 returns an ARP to the Central Dispatch Server 120, shown in FIG. 1.

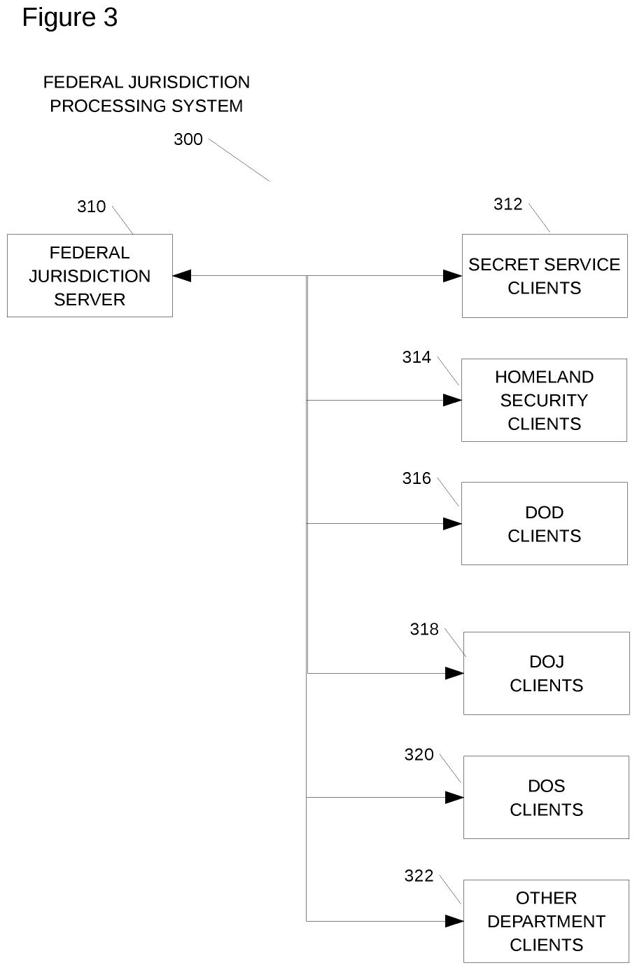

Turning now to FIG. 3, a diagram depicting the Federal Jurisdiction Processing System 300, in accordance with a preferred embodiment of the present invention; it includes the Federal Jurisdiction Server 310, and attached clients, the Secret Service Clients 312, Homeland Security Clients 314, DOD Clients 316, DOJ Clients 318, DOS Clients 320, and Other Department Clients 322.

Each of the attached clients is tasked with providing street, area, or route restrictions; these restrictions indicate if the restriction is permanent, or temporary, if temporary time data is provided. Those of ordinary skill in the art will appreciate that the information required may vary or change over time as factors such as the design requirements and jurisdictional requirements change. The primary purpose of each client is the protection of assets under its jurisdiction; however, other than the restrictions listed, no information is returned to the Central Dispatch Server 120, shown in FIG. 1, that indicates why the restriction is in place or what agency returned the restriction. The Federal Jurisdiction Server 310 is responsible for analysis of multiple requests that may attempt to discover sensitive or classified information through side channel analysis.

Each of the clients are responsible for returning restrictions regarding their designated areas; e.g., the Secret Service Clients 312 are responsible for returning restrictions concerning the President of the United States, the Vice President of the United States, the President's and Vice President's immediate families, former presidents, their spouses, and their minor children under the age of 16, major presidential and vice presidential candidates and their spouses, and foreign heads of state. The Homeland Security Clients 314, DOD Clients 316, DOJ Clients 318, DOS Clients 320, and Other Department Clients 322 each are responsible for returning restrictions regarding their designated areas. All restrictions are maintained in a database, or other data structure, contained within and maintained by the Federal Jurisdiction Server 310.

As explained above, the Federal Jurisdiction Server 310 receives signed Combined Route Packages CRP from the Central Dispatch Server 120, shown in FIG. 1; after validating the package electronic signature, the Federal Jurisdiction Server 310 compares the route contained in the Route Map to the restrictions in the database. If a restriction collides with the route, the route is rejected with a list of each collision and any relevant time data. The Central Dispatch Server 120, shown in FIG. 1, searches for an alternate route, meeting the restrictions, until found and re-sends to the Federal Jurisdiction Server 310. When the route is approved, the Federal Jurisdiction Server 310 returns an ARP to the Central Dispatch Server 120, shown in FIG. 1.

Those of ordinary skill in the art will appreciate that any of the following, and most likely many more, may result in route restrictions:
a) Road closure because of snow, ice, rain, smog, or fog,
b) Weather related events such as hurricane, tornado, or strong winds,
c) Events such as floods, ice jams, storm surge, avalanche, mud slide, or rock slide
d) Accidents, planned or unplanned evacuations
e) Fires, emergency vehicle route
f) Infrastructure related road or bridge maintenance
g) Downed power lines
h) Water main breakage
i) Accommodations for social events, parades, celebrations, marathons, other races, or sports events
j) Funeral procession
k) Planned or unplanned protests, marches, demonstrations
l) Presidential or other VIP convoy/movements
m) Military convoy or functions

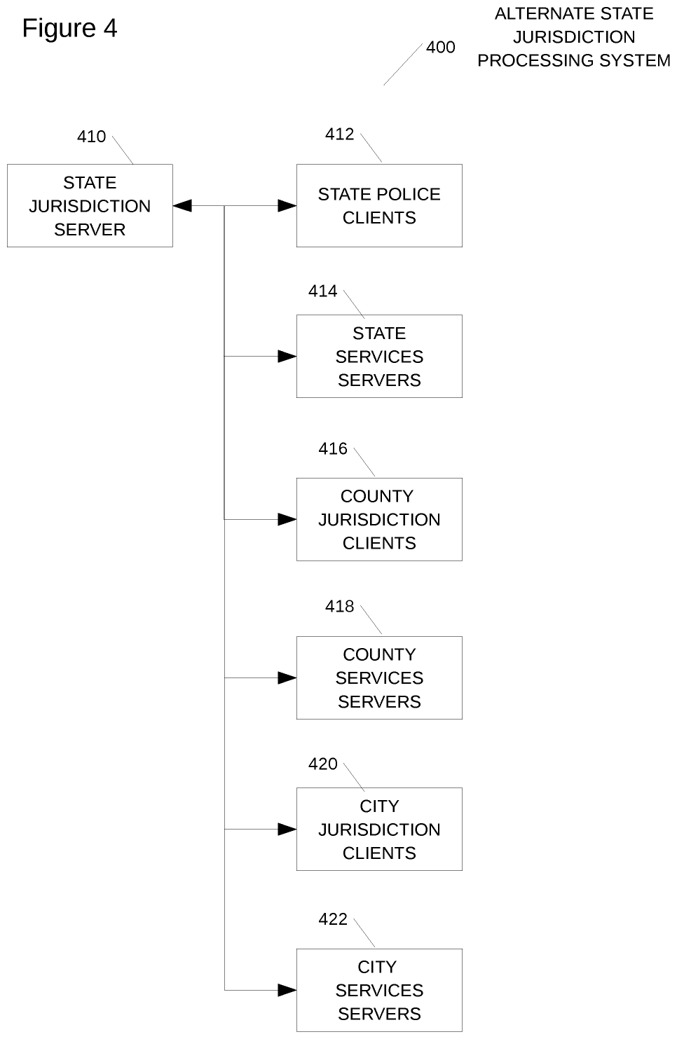

Turning now to FIG. 4, a diagram depicting the State Jurisdiction Processing System 400, in accordance with an alternate embodiment of the present invention; it includes the State Jurisdiction Server 410, and attached clients, the State Police Clients 412, State Services Servers 414, County Jurisdiction Clients 416, County Services Servers 418, City Jurisdiction Clients 420, and City Services Servers 422.

Each of the attached clients, the State Police Clients 412, County Jurisdiction Clients 416, and City Jurisdiction Clients 420, is tasked with providing street, area, or route restrictions; these restrictions indicate if the restriction is permanent, or temporary, if temporary time data is provided. Those of ordinary skill in the art will appreciate that the information required may vary or change over time as factors such as the design requirements and jurisdictional requirements change. The primary purpose of each client is the protection of assets under its jurisdiction; however, other than the restrictions listed, no information is returned to the Central Dispatch Server 120, shown in FIG. 1, that indicates why the restriction is in place or what agency returned the restriction. The State Jurisdiction Server 410 is responsible for analysis of multiple requests that may attempt to discover sensitive or classified information through side channel analysis.

Each of the clients are responsible for returning restrictions regarding their designated areas; e.g., the State Police Clients 412 are primarily responsible for returning restrictions concerning the protectees within their jurisdiction; however, they may also return other restrictions regarding their designated areas. The County Jurisdiction Clients 416, and City Jurisdiction Clients 422, each are responsible for returning restrictions regarding their designated areas. All restrictions are maintained in a database, or other data structure, contained within and maintained by the State Jurisdiction Server 410. Those of ordinary skill in the art will appreciate that in the U.S. there are fifty (50) state jurisdictions as well as the District of Columbia, over 3000 counties and county-equivalents, and almost 20,000 incorporated cities; therefore, the restrictions required by these jurisdictions may vary.

As explained above, the State Jurisdiction Server 410 receives signed Combined Route Packages CRP from the Central Dispatch Server 120, shown in FIG. 1; after validating the package electronic signature, the State Jurisdiction Server 410 compares the route contained in the Route Map to the restrictions in the database. If a restriction collides with the route, the route is rejected with a list of each collision and any relevant time data. The Central Dispatch Server 420, shown in FIG. 1, searches for an alternate route, meeting the restrictions, until found and re-sends to the State Jurisdiction Server 410. When the route is approved, the State Jurisdiction Server 410 returns an ARP to the Central Dispatch Server 120, shown in FIG. 1.

The State Services Servers 414, County Services Servers 416, and City Services Servers 422 are those services traditionally provided by the jurisdiction indicated; traditionally providing permits, licenses, highway-fee collection, and other services. In this alternate embodiment of the present invention, the Central Dispatch Server 120 shown in FIG. 1, and State Jurisdiction Server 410, now shown in the current FIG. 4, provides an automated interface to these services, reducing each jurisdictions' manpower requirement, increasing overall productivity, and lowering costs for each jurisdiction. E.g., when the Central Dispatch Server 120, receives the RRP from AV Dispatch 110, and transmits to the State Jurisdiction Server 130, as shown in FIG. 1; the RRP contains vehicle identifier, AV make and model, operator's and driver's license (if present), permit numbers, load manifest (machine readable), current location, destination, desired departure time, desired arrival time, GPS type, fuel type, allowable distance per segment, customer id(s) and customer invoice number(s). Using this information, the State Jurisdiction Server 410, now shown in the current FIG. 4, transmits the necessary data to the State Services Servers 414, County Services Servers 416, and City Services Servers 422 for checks and validation of vehicle identifier, all licenses, operator's and driver's license (if present), permits, loaded weight (from manifest) and other as required; any invalid information is flagged and returned to the State Jurisdiction Server 410 and eventually returned to AV Dispatch 110, shown in FIG. 1, as an error. Those of ordinary skill in the art will appreciate that renewal services could be processed electronically by the State Jurisdiction Server 410 in conjunction with the State Services Servers 414, County Services Servers 416, and City Services Servers 422, relieving those jurisdictions of that effort.

The descriptions of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

Acronyms and Definitions

| | |
|---|---|
| Approved Route | An electronically signed collection of data |
| Package | that gives route information and authorization |
| | to dispatch an autonomous vehicle on the |
| | specified route. This data is returned from |
| | the Central Dispatch Server to the AV Dispatch, |
| | thereafter to the Autonomous Vehicle Control |
| | System. The route data is in a standard |
| | format such as the GPS Exchange Format. |
| ARP | See Approved Route Package |
| AV | Autonomous Vehicle, for the purposes of this |
| | invention, refers to SAE specification J3016, |
| | Level 2 through Level 5 vehicles, as well |
| | autonomous aerial vehicles. |
| Combined Route | A collection of data consisting of a Route Map |
| Package | and Route Request Package; this information is |
| | sent to the Federal and State Jurisdiction |
| | Servers. |
| CRP | See Combined Route Package |
| Global Navigation | The standard generic term for satellite |
| Satellite System | navigation systems that provide autonomous |
| | geo-spatial positioning with global coverage. |
| GPS | See Global Positioning System |
| GPS Exchange | An XML schema designed as a common GPS data |
| Format | format for software applications. It can be |
| | used to describe waypoints, tracks, and routes. |
| Lawful Stop and | Refers to a situation where law enforcement |
| Search | may legally request a vehicle to pull over |
| | and search (inspect) the vehicle |
| Load Tracking | A collection of data sent from AI Load Tracking |
| Response | to the Central Dispatch Server in response to |
| | a Route Request Package. |
| LSS | See Lawful Stop and Search |
| LTR | See Load Tracking Response |
| Non-repudiation | A link between a message and the sender of the |
| of origin | message that provides legal evidence that a |
| | person in fact sent the message. |
| Non-repudiation of | A link between a message and the receiver of the |
| receipt | message that provides legal evidence that a |
| | person in fact received the message. |
| PKI | See Public Key Infrastructure |
| Public Key | A set of roles, policies, and procedures needed to |
| Infrastructure | create, manage, distribute, use, store, and revoke |
| | digital certificates and manage public-key |
| | encryption. |
| RM | See Route Map |
| Route Map | A collection of data returned from the Mapping |
| | Server to the Central Dispatch Server in response |
| | to a Route Request Package |
| Route Package | A collection of data sent from the State and Federal |
| Approval | Jurisdiction Servers in response to a CRP |
| Route Request | A collection of data sent from the Central Dispatch |
| Package | Server to the Mapping Server, State and Federal |
| | Jurisdiction Servers to receive route information and |
| | authorization to dispatch an autonomous vehicle. |
| | The RRP fields required are (but is not limited to) |
| | vehicle identifier, AV make and model, operator's |
| | and driver's license (if present), permit numbers, |
| | load manifest (machine readable), current location, |
| | destination, desired departure time, desired arrival |
| | time, GPS type, fuel type, allowable distance per |
| | segment, customer id(s) and customer invoice |
| | number(s) |
| RPR | See Route Package Response |
| RRP | See Route Request Package |
| SAE | Society of Automotive Engineers |
| Vehicle Identifier | A vehicle identifier can be a license plate |
| (VID) | number, a U.S. Department of Transportation |
| | (USDOT) Identification Number or other identifier |
| | that uniquely identifies a vehicle. Companies that |
| | operate commercial vehicles transporting passengers |
| | or hauling cargo in interstate commerce must be |
| | registered with the U.S. Federal Motor Carrier |
| | Safety Administration (FMCSA) and must have a |
| | USDOT Number. |
| Updated Route | An electronically signed collection of data that |
| Package | updates a previous route with new route information |
| | and authorization to dispatch an autonomous vehicle |
| | on the specified route. This data is sent |
| | asynchronously from the Central Dispatch Server to |
| | the AV Dispatch, thereafter to the Autonomous |
| | Vehicle Control System in route. The route data |
| | is in a standard format such as the GPS |
| | Exchange Format. |
| URP | See Updated Route Package |

What is claimed is:

1. A routing method that comprises:
receiving from an Autonomous vehicle (AV) dispatch client a Route Request Package (RRP) including at least a vehicle Identifier, a load manifest, a customer id, a customer invoice number, a destination, and a current location;
forwarding the RRP to a Load Tracking Server to obtain a Load Tracking Response (LTR), the LTR indicating whether the load manifest has been electronically validated for that customer invoice number and that customer id.

2. The method of claim 1, wherein the LTR flags the load for manual inspection if the load manifest hasn't been electronically validated.

3. A routing method that comprises:
receiving from an Autonomous vehicle (AV) dispatch client a Route Request Package (RRP) including at least a vehicle Identifier, a load manifest, a customer id, a customer invoice number, a destination, and a current location;
obtaining a Route Map (RM) based on at least the destination and current location;
sending a Combined Route Package (CRP) to one or more jurisdiction servers to obtain a Route Package Response (RPR), the CRP including the RRP and the Route Map, the RPR indicating whether the CRP violates any of the restrictions being tracked by each jurisdiction server; and
providing an Approved Route Package (ARP) to the AV dispatch client if no violations are indicated.

4. The routing method of claim 3, further comprising:
generating a modified Route Map if the RPR indicates restriction violations;
providing a modified CRP including the modified Route Map to the one or more jurisdiction servers to obtain a modified RPR; and
repeating said generating and providing until the modified RPR indicates no violations.

5. The routing method of claim 3, further comprising:
forwarding the RRP to a Load Tracking Server to obtain a Load Tracking Response (LTR), the RTR indicating whether the load manifest has been electronically validated for that customer invoice number and that customer id,
wherein the LTR indicates whether the load manifest has been electronically validated.

6. The routing method of claim 3, wherein the one or more jurisdiction servers includes a federal jurisdiction server that uses the CRP to query federal client-specific databases, each federal client-specific database tracking AV-related restrictions imposed by a federal client, the federal clients including at least one of: Secret Service, Homeland Security, Department of Defense, Department of Justice, and Department of State.

7. The routing method of claim 6, wherein the one or more jurisdiction servers includes multiple state jurisdiction servers that each use the CRP to query state client-specific databases, each state client-specific database tracking AV-related restrictions imposed by a state client, the state clients including at least one of: State Police, State Services, County Services, and City Services.

8. The routing method of claim 7, wherein the AV-related restrictions tracked by the state client-specific databases and the federal client-specific databases include at least one of: restricted areas, locations of protected individuals, road closures, accidents, hazard areas, disaster areas, routes for emergency services, and event locations.

9. A routing system that comprises:
a central dispatch server that accepts a Route Request Package (RRP) from an Autonomous vehicle (AV) dispatch client, the RRP including at least a vehicle Identifier, a load manifest, a customer id, a customer invoice number, a destination, and a current location; and
a Load Tracking Server, the central dispatch server forwarding the RRP to a Load Tracking Server to obtain a Load Tracking Response (LTR), the LTR indicating whether the load manifest has been electronically validated for that customer invoice number and that customer id.

10. The routing system of clam 9, wherein the central dispatch server flags the load for manual inspection if the LTR indicates the load manifest hasn't been electronically validated.

11. A routing system that comprises:
a central dispatch server that accepts a Route Request Package (RRP) from an Autonomous vehicle (AV) dispatch server, the RRP including at least a vehicle Identifier, a load manifest, a customer id, a customer invoice number, a destination, and a current location,
the central dispatch server accessing a mapping server to obtain a Route Map based on at least the destination and current location,
the central dispatch server further sending a Combined Route Package (CRP) to one or more jurisdiction servers to obtain a Route Package Response (RPR), the CRP including the RRP and the Route Map, the RPR indicating whether the CRP violates any of the restrictions being tracked by each jurisdiction server, and
the central dispatch server providing an Approved Route Package (ARP) to the AV dispatch server contingent upon the RPR indicating no violations.

12. The routing system of claim 11, wherein contingent upon the RPR indicating restriction violations, the central dispatch server provides a modified CRP including a modified Route Map to the one or more jurisdiction servers to obtain a modified RPR, and wherein the central dispatch server repeats said providing until the modified RPR indicates no violations.

13. The routing system of claim 11, wherein the central dispatch server forwards the RRP to a Load Tracking Server to obtain a Load Tracking Response (LTR), the LTR indicating whether the load manifest has been electronically validated for that customer invoice number and that customer id.

14. The routing system of claim 11, wherein the one or more jurisdiction servers includes a federal jurisdiction server that uses the CRP to query federal client-specific databases, each federal client-specific database tracking AV-related restrictions imposed by a federal client, the federal clients including at least one of: Secret Service, Homeland Security, Department of Defense, Department of Justice, and Department of State.

15. The routing system of claim 14, wherein the one or more jurisdiction servers includes multiple state jurisdiction servers that each use the CRP to query state client-specific databases, each state client-specific database tracking AV-related restrictions imposed by a state client, the state clients including at least one of: State Police, State Services, County Services, and City Services.

16. The routing system of claim 15, wherein the AV-related restrictions tracked by the state client-specific databases and the federal client-specific databases include at least one of: restricted areas, locations of protected individuals, road closures, accidents, hazard areas, disaster areas, routes for emergency services, and event locations.

17. The routing system of claim 11, wherein the one or more jurisdiction servers includes multiple state jurisdiction servers that each use the CRP to query state client-specific databases, each state client-specific database tracking AV-related restrictions imposed by a state client, the state clients including at least one of: State Police, State Services, County Services, and City Services.
